(19) United States
(12) Patent Application Publication
(10) Pub. No.: US 2019/0197787 A1
(43) Pub. Date: Jun. 27, 2019

(54) AUGMENTED REALITY SYSTEMS AND METHODS FOR SUPPLY CHAIN

(71) Applicant: Walmart Apollo, LLC, Bentonville, AR (US)

(72) Inventors: Jimmy L. Easter, Bentonville, AR (US); Jason Kyle Wellington, Bella Vista, AR (US)

(21) Appl. No.: 16/230,078

(22) Filed: Dec. 21, 2018

Related U.S. Application Data
(60) Provisional application No. 62/609,516, filed on Dec. 22, 2017.

(51) Int. Cl. G06T 19/00; G06F 3/0482; G06F 3/0488

(52) U.S. Cl. CPC G06T 19/006; G06T 2200/24; G06F 3/04883; G06F 3/0482

(57) ABSTRACT

In some embodiments, apparatuses and methods are provided herein useful to augmented reality systems in a supply chain. In some embodiments, an augmented reality system comprises a mobile device comprising an image capture device, a display device configured to present a view of the containers and an augmented reality presentation including the container information, a user input device configured to receive user input selecting one of the containers, and a control circuit configured to receive the selection of the one of the containers, identify, based on a container identifier, the one of the containers, cause transmission of a request for container information for the one of the containers, receive from the backend server, the container information for the one of the containers, and generate the augmented reality presentation, wherein the augmented reality presentation includes the container information for the one of the containers superimposed over the view of the containers.

### CROSS-REFERENCE TO RELATED APPLICATION

This application claims the benefit of U.S. Provisional Application No. 62/609,516, filed Dec. 22, 2017, which is incorporated by reference in its entirety herein.

### TECHNICAL FIELD

This invention relates generally to augmented reality (AR) systems and, more specifically, to AR systems for use in a supply chain.

### BACKGROUND

Commercial products move through a complex product distribution supply chain en route to retailers for sale. Typically, manufacturers ship products to distribution centers. After processing at a distribution center, the products are shipped to retailers. Throughout this movement, records are kept of which containers should be arriving where and when. Complete and organized data are essential to ensuring that products are delivered on time, and to the correct retailer. Any errors, incorrect deliveries, or late deliveries can result in substantial cots to retailers in the form of lost sales.

Typically, records for products, and containers in which the products are shipped, are kept by hand (i.e., on paper). Accordingly, if a driver wishes to obtain more information regarding a product or container, he or she must reference the paper records. As one example, if the driver wishes to determine what products are in a container, the driver must determine an identifier for the container, retrieve the paper records, then find the information he or she is seeking. Such a process can be difficult and cumbersome for drivers, increasing the likelihood that an error will occur. Consequently, a need exists for better systems, methods, and apparatuses for drivers, as well as other involved in the loading, unloading and delivery of products, to acquire information about the products and/or containers.

### BRIEF DESCRIPTION OF THE DRAWINGS

Disclosed herein are embodiments of systems, apparatuses and methods pertaining to augmented reality (AR) systems for use in a supply chain. This description includes drawings, wherein:

FIG. 1 depicts a cargo area 102 of a delivery vehicle and a mobile device 108 presenting an augmented reality presentation of the cargo area 102 of the delivery vehicle, according to some embodiments;

FIG. 2 depicts a mobile device 202 presenting an augmented reality presentation including container information 208 for a container 206, according to some embodiments;

FIG. 3 is a block diagram of a system 300 for presenting container information for containers containing commercial products and the containers move through a product distribution supply chain, according to some embodiments; and

FIG. 4 is a flow chart including example operations for presenting augmented reality container information for containers containing commercial products as the containers move through a product distribution supply chain, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to augmented reality (AR) systems in a supply chain. In some embodiments, an augmented reality system for presenting container information for containers containing commercial products as the containers move through a product distribution supply chain comprises a mobile device, wherein the mobile device comprises an image capture device, a display device, wherein the display device is configured to present a view of the containers as a user moves the mobile device with respect to the containers and an augmented reality presentation including the container information, a user input device, wherein the user input device is configured to receive user input selecting one of the containers presented in the view of the containers, and a control circuit, wherein the control circuit is configured to receive, via the user input device, the selection of the one of the containers, identify, based on a container identifier, the one of the containers, cause transmission, to a backend server, of a request for container information for the one of the containers, receive from the backend server, the container information for the one of the containers, and generate the augmented reality presentation, wherein the augmented reality presentation includes the container information for the one of the containers superimposed over the view of the containers, and wherein the container information for the one of the containers is selectable and navigable via the mobile device.

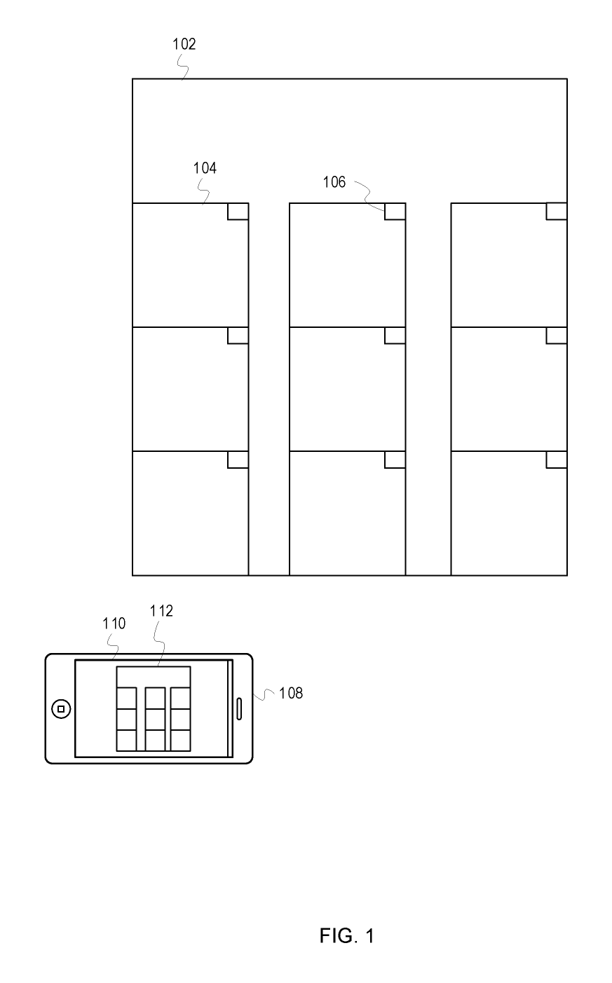

As previously discussed, tracking the movement of products through a product distribution supply chain is a complex process. Any errors that occur can be costly to retailers, suppliers, and/or delivery agents. Currently, records of products, containers, delivery locations, etc. are kept by hand. Dealing with, and acquiring information from, paper records can be cumbersome and prone to error. Embodiments of the inventive subject matter make this process easier by providing an augmented reality (AR) system. The AR system allows drivers, as well as other personnel, to quickly ascertain information about containers on a delivery vehicle. In some embodiments, the AR system works with a mobile device (e.g., a smartphone, tablet, computer, etc.) to identify containers and present, after retrieving if necessary, information about the containers. The discussion of FIG. 1 provides and overview of such a system.

FIG. 1 depicts a cargo area 102 of a delivery vehicle and a mobile device 108 presenting an augmented reality presentation of the cargo area 102 of the delivery vehicle, according to some embodiments. The cargo area 102 includes a plurality of containers 104. Each of the containers 104 includes an identifier 106. The identifiers 106 can be a visible marker (e.g., an alphanumeric code, barcode, etc.) or a transmitter (e.g., an RFID tag). Each of the identifiers 106 includes information identifying one of the containers 104.

The driver, or any other suitable person, can manipulate the mobile device 108 to present a view of the cargo area 102 via a display device 110 of the mobile device 108. For example, the mobile device 108 can utilize an image capture device, such as a camera, to capture images of the cargo area 102. This can be done in real, or near real, time, as the driver moves the mobile device 108 with respect to the container 104. Alternatively, or additionally, the mobile device 108 can capture static images of the cargo area 102.

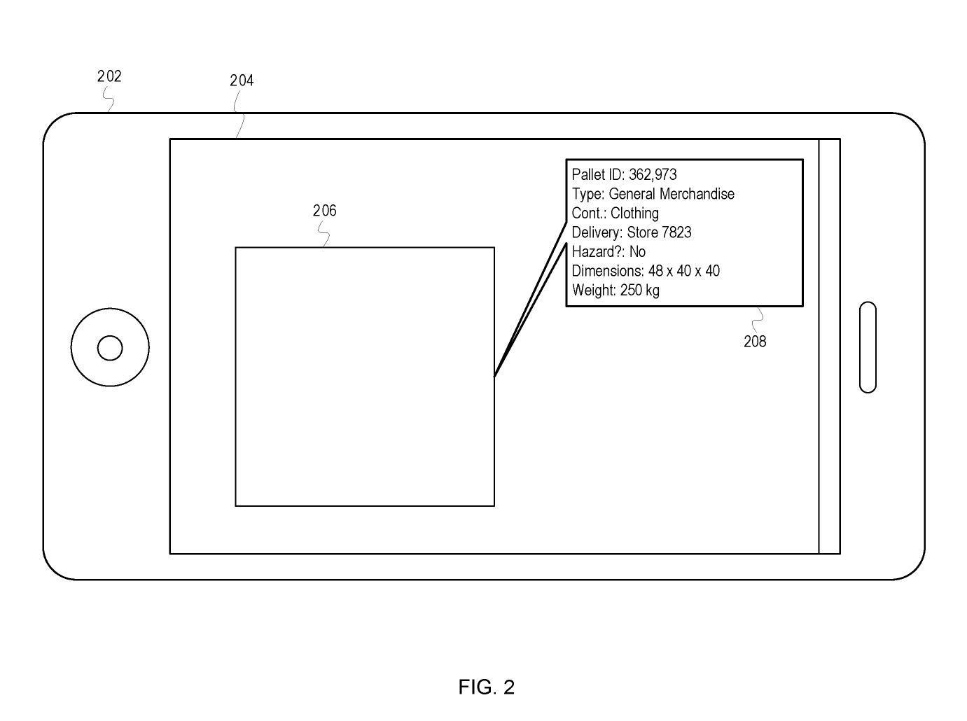

The driver can select one or more of the containers via a user input device of the mobile device 108 (e.g., as depicted in FIG. 1, the touchscreen display device 110 capable of receiving touch input). Upon selection of one or more of the containers 104, the mobile device 108 presents container information for the one or more of the selected containers 104. The mobile device generates a virtual reality presentation 112 of at least some of the containers 104, including the container information. In some embodiments, the container information is selectable and/or navigable via the mobile device 108, as described in additional detail with respect to FIG. 2.

While the discussion of FIG. 1 provides an overview of an augmented reality system for presenting container information, the discussion of FIG. 2 provides additional detail regarding the presentation of an augmented reality presentation on a mobile device.

FIG. 2 depicts a mobile device 202 presenting an augmented reality presentation including container information 208 for a container 206, according to some embodiments. In the example depicted in FIG. 2, the driver has selected the container 206. Accordingly, the augmented reality presentation presented via the display device 204 includes container information 208 for the container 206. The container information 208 can include any desired information such as a list of items in a container, a type of items in a container, a number of items in container, any warnings associated with a container, a weight of a container, dimensions of a container, an image of a product in a container, an image of product packaging of a product in a container, delivery information for a container, compliance information for a container, etc. As depicted in FIG. 2, the container information 208 includes a pallet ID, type of product within the container 206, contents of the container 206, delivery information for the container (e.g., a store at which the container 206 is to be delivered), warnings for the container 206 (e.g., whether the container 206 incudes any hazardous materials), dimensions of the container 206, and a weight of the container 206.

In some embodiments, the information included in the container information 208 can be configurable. For example, the driver can choose what information will be presented in the container information 208. Additionally, in some embodiments, the driver can navigate and select information from the container information 208. For example, the driver could select the “Type” category to retrieve additional information about a type of products in the container 206.

Some, or all, of the container information can be stored locally on the mobile device 202. For example, the driver can load the container information 208 for all containers in the delivery vehicle, prior to departing. In some embodiments, the driver can load this information onto the mobile device 202 by downloading the information for a delivery from a backend server prior to leaving a distribution center (e.g., by scanning or entering an identifier associated with a delivery). While storing the container information 208 locally can increase the speed at which the container information 208 is retrieved and decrease the dependence upon connectivity with the backend server, it requires the mobile device 202 to be capable of storing an increased amount of data. Accordingly, in some embodiments, the mobile device 202 may store only limited, if any, container information 208 locally. In such embodiments, the mobile device 202 can make calls to the backend server to retrieve, on demand, any of the container information 208 not stored locally.

In addition to providing the container information 208 upon selection, in some embodiments, the mobile device 202 can present an alert if a container is found on the delivery vehicle that should not be there. For example, if as the driver views the cargo area of the delivery vehicle via the mobile device 202, the mobile device determines that a container is present that should have already been delivered, or is not supposed to be included on the delivery vehicle, the mobile device 202 can present an alert to the driver via the display device 204. This alert can be generic (e.g., a notification indicating that there is a container present that should not be there) or specific to the container (e.g., a notification indicating that a specific container should have been delivered/unloaded at a previous stop). The mobile device 202 can make this determination based on container identifiers read while the driver views the cargo area via the mobile device 202.

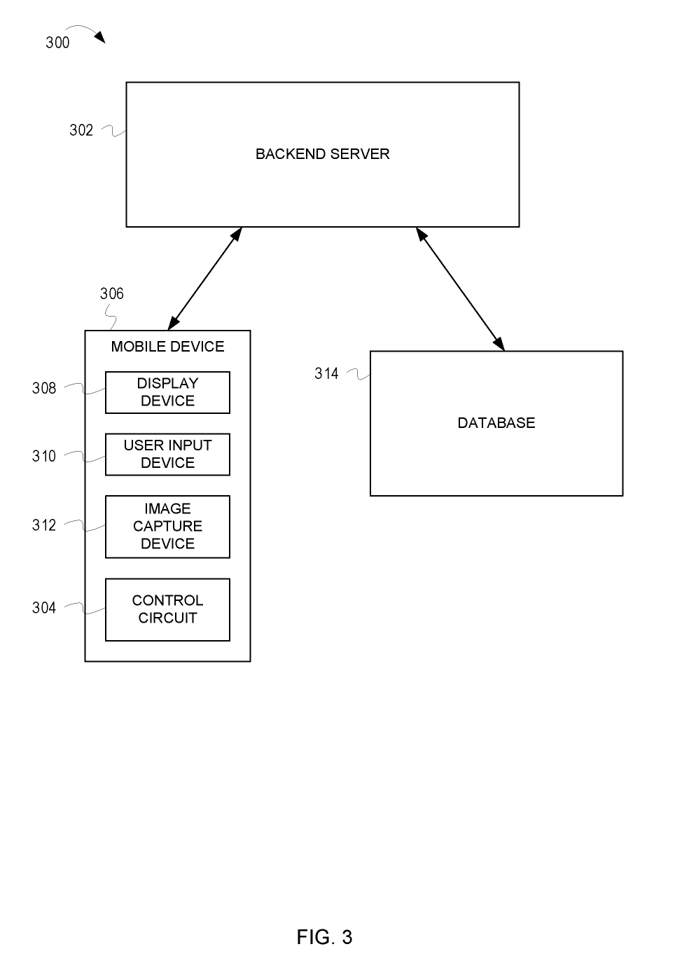

While the discussion of FIG. 2 provides additional detail regarding the presentation of an augmented reality presentation, the discussion of FIG. 3 provides additional detail regarding an augmented reality system for presenting container information.

FIG. 3 is a block diagram of a system 300 for presenting container information for containers containing commercial products and the containers move through a product distribution supply chain, according to some embodiments. The system 300 includes a backend server 302, a mobile device 306, and a database 314. The mobile device 306 includes a display device 308, a user input device 310, an image capture device 312, and a control circuit 304.

The mobile device 306 captures images via the image capture device 312. When used as part of the system 300, the image capture device 312 captures images of the cargo area of a delivery vehicle (or loading dock, reception area, etc.). The mobile device 306 presents the images via the display device 308. The images can either be static (i.e., still images) or video images as the mobile device 306 is moved with respect to the containers. The mobile device 306 receives user input via the user input device 310. Although depicted separately, in some embodiments the display device 308 and the user input device 310 can be the same device (e.g., a touchscreen). The user input selects one or more containers presented via the display device 308. In embodiments in which container identifiers are visual identifiers, the image capture device 312 captures the product identifiers. In embodiments in which the container identifiers are not visual, the mobile device can capture the product identifiers via other means, such as an RFID reader, auditory input devices, NFC radio, etc.

The control circuit 304 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 304 is configured (for example, by using corresponding programming as will be well understood by those skilled in the art) to carry out one or more of the steps, actions, and/or functions described herein.

By one optional approach the control circuit 304 operably couples to a memory. The memory may be integral to the control circuit 304 or can be physically discrete (in whole or in part) from the control circuit 304 as desired. This memory can also be local with respect to the control circuit 304 (where, for example, both share a common circuit board, chassis, power supply, and/or housing) or can be partially or wholly remote with respect to the control circuit 304 (where, for example, the memory is physically located in another facility, metropolitan area, or even country as compared to the control circuit 304).

This memory can serve, for example, to non-transitorily store the computer instructions that, when executed by the control circuit 304, cause the control circuit 304 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 304 receives, from the user input device 310, the selection of the container. The control circuit 304 identifies the container based on the container identifier. If the mobile device 306 includes container information stored locally, the mobile device can present the container information via the display device 308. However, if some, or all, of the container information is not stored locally, the control circuit 304 can transmit a request to the backend server 302 for the container information. In some embodiments, the backend server 302 retrieves the container information from the database 314. After retrieving the container information from the database 314 (if necessary), the backend server 302 transmits the container information to the control circuit 304. The control circuit 304 generates the augmented reality presentation and causes presentation of the augmented reality presentation via the display device 308. The augmented reality presentation includes the container information superimposed over the view of the containers. In some embodiments, the user can select or request additional container information by navigating and/or selecting the container information. In such embodiments, the control circuit can update the augmented reality presentation to include the requested information, requesting the information from the backend server 302 as necessary.

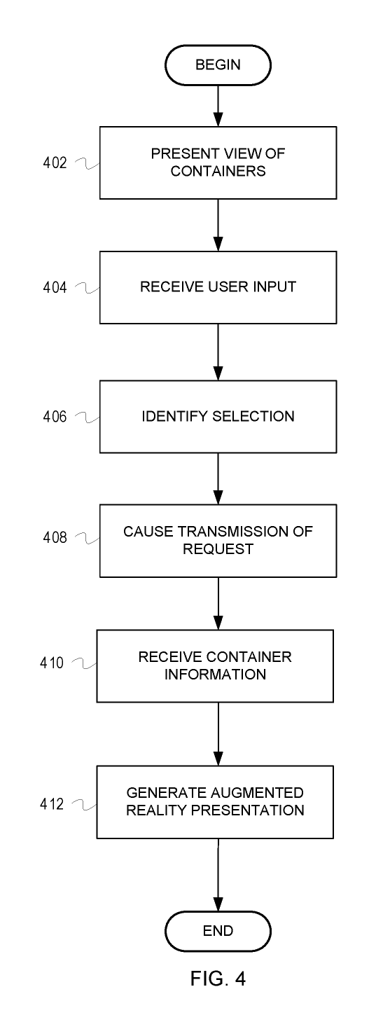

While the discussion of FIG. 3 provides additional information regarding an augmented reality system for presenting container information, the discussion of FIG. 4 describes example operations for presenting an augmented reality presentation including container information.

FIG. 4 is a flow chart including example operations for presenting augmented reality container information for containers containing commercial products as the containers move through a product distribution supply chain, according to some embodiments. The flow begins at block 402.

At block 402, a view of containers is presented. For example, a mobile device can present the view of the containers as a user moves the mobile device with respect to the containers. The containers can be in a delivery vehicle, in a warehouse, on a shipping dock, etc. The mobile device captures images of the containers as the user moves the mobile device with respect to the containers. The flow continues at block 404.

At block 404, user input is received. For example, the mobile device can receive the user input via a user input device. The user input selects a container from the view of the containers. For example, the user can select a specific container by highlighting the container or clicking on the container. The flow continues at block 406.

At block 406, the selection is identified. For example, a control circuit can identify the selected container. The control circuit identifies the selected container based on a container identifier. For example, the container identifier can include an RFID tag. In this example, the RFID tag transmits the container identifier to the mobile device. The flow continues at block 408.

At block 408, a request is transmitted. For example, the control circuit can cause transmission of the request. The request is for container information associated with the selected container. In some embodiments, the mobile device stores the container information locally and the container information is retrieved from a local memory device. In other embodiments, some, or all, of the container information is stored remotely, for example at a backend server or a database. In such embodiments, the control circuit causes transmission of the request to the backend server. The flow continues at block 410.

At block 410, the container information is received. For example, the control circuit can receive the container information from the local memory and/or the backend server. In some embodiments, after receiving the container information, the control circuit stores the container information locally for easy retrieval. The flow continues at block 412.

At block 412, an augmented reality presentation is generated. For example, the control circuit can generate the augmented reality presentation. The augmented reality presentation includes the container information superimposed over the view of the containers. In some embodiments, the augmented reality presentation includes one or more menus. For example, the menus can allow the user to select and/or request additional container information and/or browse the container information. In such embodiments, the container information is selectable and navigable via the mobile device. Additionally, in some embodiments, the augmented reality presentation can include an indicia of the container, such as a visual identifier of the container.

In some embodiments, an augmented reality system for presenting container information for containers containing commercial products as the containers move through a product distribution supply chain comprises a mobile device, wherein the mobile device comprises an image capture device, a display device, wherein the display device is configured to present a view of the containers as a user moves the mobile device with respect to the containers, and an augmented reality presentation including the container information, a user input device, wherein the user input device is configured to receive user input selecting one of the containers presented in the view of the containers, and a control circuit, wherein the control circuit is configured to receive, via the user input device, the selection of the one of the containers, identify, based on a container identifier, the one of the containers, cause transmission, to a backend server, a request for container information for the one of the containers, receive from the backend server, the container information for the one of the containers, and generated the augmented reality presentation, wherein the augmented reality presentation includes the container information for the one of the containers superimposed over the view of the containers, and wherein the container information for the one of the containers is selectable and navigable via the mobile device.

In some embodiments, an apparatus and a corresponding method performed by the apparatus comprises presenting, via a display device of a mobile device, a view of the containers as a user moves the mobile device with respect to the containers and an augmented reality presentation including the container information, receiving, via a user input device, user input selecting one of the containers presented in the view of the containers, identifying, based on the user input, the selection of the one of the containers, causing transmission, to a backend server, a request for container information for the one of the containers, receiving, from the backend server, a request for container information for the one of the containers, receiving, from the backend server, the container information for the one of the containers, and generating the augmented reality presentation, wherein the augmented reality presentation includes the container information for the one of the containers superimposed over the view of the containers, wherein the information for the one of the containers is selectable and navigable via the mobile device.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An augmented reality system for presenting container information for containers containing commercial products as the containers move through a product distribution supply chain, the system comprising:
a mobile device, wherein the mobile device comprises;
an image capture device;
a display device, wherein the display device is configured to present a view of the containers as a user moves the mobile device with respect to the containers and an augmented reality presentation including the container information;
a user input device, wherein the user input device is configured to receive user input selecting one of the containers presented in the view of the containers; and
a control circuit, wherein the control circuit configured to:
receive, via the user input device, the selection of the one of the containers;
identify, based on a container identifier, the one of the containers;
cause transmission, to a backend server, of a request for container information for the one of the containers;
receive, from the backend server, the container information for the one of containers; and
generate the augmented reality presentation, wherein the augmented reality presentation includes the container information for the one of the containers superimposed over the view of the containers, wherein the container information for the one of the containers is selectable and navigable via the mobile device.

2. The augmented reality system of claim 1, wherein the container identifier is received from an RFID tag.

3. The augmented reality system of claim 1, wherein the container identifier is a visual marker.

4. The augmented reality system of claim 1, wherein the container information includes one or more of a list of items in a container, a type of items in a container, a number of items in container, any warnings associated with a container, a weight of a container, dimensions of a container, an image of a product in a container, an image of product packaging of a product in a container, delivery information for a container, and compliance information for a container.

5. The augmented reality system of claim 1, wherein the user input device is a touchscreen, and wherein the selection is via touch input.

6. The augmented reality system of claim 1, wherein the control circuit is further configured to:
determine, based on the container identifier, that the one of the containers should not be present; and
present, via the mobile device, an alert indicating that the one of the containers should be present.

7. The augmented reality system of claim 6, wherein the one of the containers should not be present because the one of the containers should have be previously unloaded.

8. The augmented reality system of claim 1, wherein the augmented reality presentation includes at least one menu, and wherein the user can navigate the at least one menu to browse the container information for the one of the containers.

9. The augmented reality system of claim 1, wherein the mobile device is configured to, after receipt of the container information for the one of the containers, store the container information for the one of the containers.

10. The augmented reality system of claim 1, wherein the augmented reality presentation includes an indicia of the one of the containers.

11. A method for presenting augmented reality container information for containers containing commercial products as the containers move through a product distribution supply chain, the method comprising:
presenting, via a display device of a mobile device, a view of the containers as a user moves the mobile device with respect to the containers and an augmented reality presentation including the container information;
receiving, via a user input device, user input selecting one of the containers presented in the view of the containers;
identifying, based on the user input, the selection of the one of the containers;
causing transmission, to a backend server, a request for container information for the one of the containers;
receiving, from the backend server, the container information for the one of the containers; and
generating the augmented reality presentation, wherein the augmented reality presentation includes the container information for the one of the containers superimposed over the view of the containers, wherein the information for the one of the containers is selectable and navigable via the mobile device.

12. The method of claim 11, wherein the container identifier is received from an RFID tag.

13. The method of claim 11, wherein the container identifier is a visual marker.

14. The method of claim 11, wherein the container information includes one or more of a list of items in a container, a type of items in a container, a number of items in container, any warnings associated with a container, a weight of a container, dimensions of a container, an image of a product in a container, an image of product packaging of a product in a container, delivery information for a container, and compliance information for a container.

15. The method of claim 11, wherein the user input device is a touchscreen, and wherein the user input is touch input.

16. The method of claim 11, further comprising:
determining, based on the container identifier, that the one of the containers should not be present; and
presenting, via the mobile device, an alert indicating that the one of the containers should not be present.

17. The method of claim 16, wherein the one of the container should not be present because the one of the container should have been previously unloaded.

18. The method of claim 11, wherein the augmented reality presentation includes at least one menu, and wherein the user can navigate the at least one menu to browse the container information for the one of the containers.

19. The method of claim 11, further comprising:
storing, after receiving the container information for the one of the containers, the container information for the one of the containers.

20. The method of claim 11 wherein the augmented reality presentation includes an indicia of the one of the containers.
